(19) United States
(12) Patent Application Publication
(10) Pub. No.: US 2013/0238152 A1
(43) Pub. Date: Sep. 12, 2013

(54) GRID IMPROVEMENT METHOD

(71) Applicants: John F. Kelly, Elmhurst, IL (US); Gregory C. Rouse, Sarasota, FL (US)

(72) Inventors: John F. Kelly, Elmhurst, IL (US); Gregory C. Rouse, Sarasota, FL (US)

(21) Appl. No.: 13/789,556

(22) Filed: Mar. 7, 2013

Related U.S. Application Data
(60) Provisional application No. 61/607,995, filed on Mar. 7, 2012.

(51) Int. Cl. G06F 1/26

(52) U.S. Cl. CPC G06F 1/26
USPC 700/286

(57) ABSTRACT

A grid performance improvement method including simultaneous use of multiple primary indicia of performance.

### PRIORITY CLAIM

This application claims the benefit of U.S. Prov. App. No. 61/607,995 filed Mar. 7, 2012 titled GRID IMPROVEMENT METHOD which is incorporated herein in its entirety and for all purposes.

### BACKGROUND OF THE INVENTION

1. Field of the Invention

The invention relates to a process. In particular, the invention includes a method for improving the performance of an electric grid.

2. Discussion of the Related Art

While a functional, widely distributed electric grid is not alone sufficient for national success, examples of a large nation-state that remains politically stable and economically prosperous without one are scarce. Grid improvement driven by carefully designed measures of grid performance is therefore a matter of national interest.

Although it is not the current situation, grid improvement should be driven by a broad spectrum of electric power industry stakeholders. These include generators, transmission companies, distributors, consumers, commercial entities, industry, electric industry suppliers of goods and services, and those affected by the activities and operations of any of these.

Indeed, historical standards for measuring grid performance reflect, to a large extent, the interests of the electric power industry. These grid performance measures therefore ignore significant non-industry interests. And, even when particular non-industry interests are recognized, these are often drowned out by unfair balancing against competing interests.

Although a general awareness of this problem has yet to develop, the writers find historical measures of grid performance fail to identify grid improvement initiatives considering a broad spectrum of stakeholder interests. And, to the extent grid performance measures do identify and lead to non-capacity grid improvements, these initiatives have been sporadic and lack coordination on a large scale. Evidence of this singular vision of grid improvement is that since the grid's inception, grid capacity increases have persistently dominated grid investments.

Grid performance measures other than those leading first and primarily to grid capacity improvements are needed.

### SUMMARY OF THE INVENTION

The present invention provides methods for improving grid performance through use of a rating system having multiple primary indicia of electric infrastructure performance. In various embodiments, each primary indicia of electric infrastructure performance is based on corresponding secondary indicia of performance.

In an embodiment, a method of improving electric grid performance comprising the steps of; providing a governing body, a rating system, and certification candidates; the rating system incorporating reliability as a first primary indicia of performance, safety as a second primary indicia of performance, power quality as a third primary indicia of performance, cost as a fourth primary indicia of performance, efficiency as a fifth primary indicia of performance, environment as a sixth primary indicia of performance, and consumer empowerment as a seventh primary indicia of performance; defining multiple factors for scoring each primary indicia of performance; the governing body determining a required primary indicia certifying score for each primary indicia of performance, determining an overall certifying score for a plurality of the primary indicia of performance, and authorizing auditors to perform audits on certification candidates; selecting infrastructure certification candidates from at least one of electric generating infrastructure, electric transmission infrastructure, and electric distribution infrastructure; auditing selected infrastructure candidates; issuing a certificate of registration to infrastructure candidates that meet governing body requirements including certifying score as verified by an audit; and, the governing body causing periodic publication of a list indicating electric industry participants holding certificates of registration.

### BRIEF DESCRIPTION OF THE DRAWINGS

The present invention is described with reference to the accompanying figures. These figures, incorporated herein and forming part of the specification, illustrate the present invention and, together with the description, further serve to explain the principles of the invention and to enable a person skilled in the relevant art to make and use the invention.

FIG. 1 shows a block diagram of the bulk electric grid.

FIG. 2 shows a block diagram of targeted revenue models.

### DETAILED DESCRIPTION OF THE PREFERRED EMBODIMENTS

The disclosure provided in the following pages describes examples of some embodiments of the invention. The designs, figures, and descriptions are non-limiting examples of certain embodiments of the invention. For example, other embodiments of the disclosed device may or may not include the features described herein. Moreover, disclosed advantages and benefits may apply to only certain embodiments of the invention and should not be used to limit the disclosed inventions.

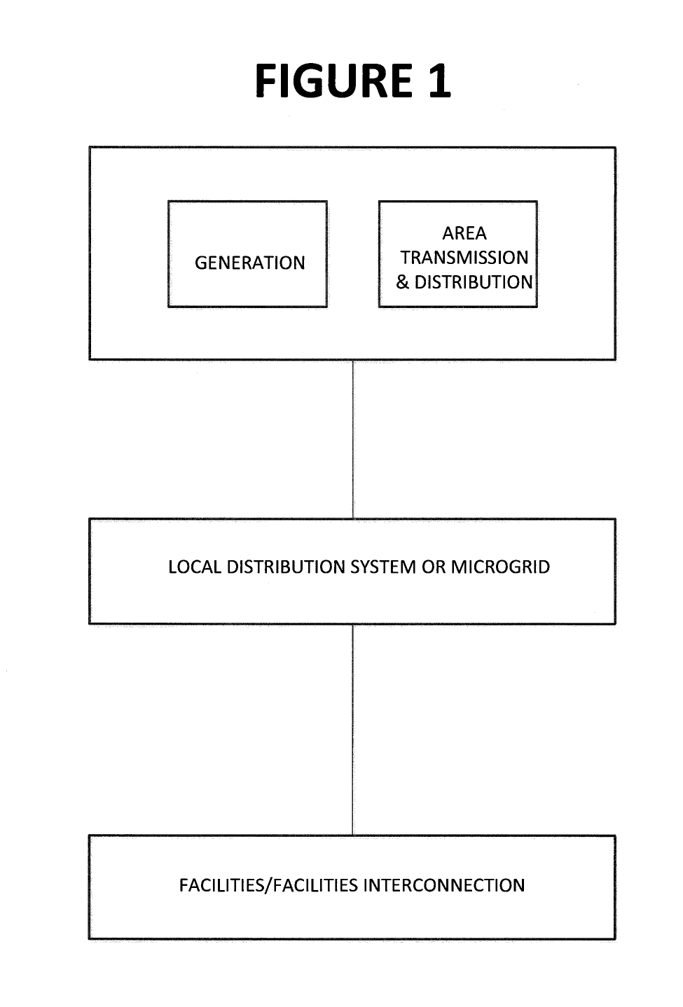

As shown in FIG. 1, electric industry infrastructure can be described as a hierarchy with the bulk power system (“the grid”) supplying, in turn, area transmission and distribution, local distribution system or microgrid, and facilities.

The bulk power system is defined by the Regional Reliability Organization, the electrical generation resources, transmission lines, interconnections with neighboring systems and associated equipment, generally operated at voltages of 100 kV or higher.¹ Glossary of Terms in the NERC Reliability Standards, page 8 of 51, http:/www.nerc.com/files/Reliability Standards Cornpltet Set.pff

Area transmission and distribution is an area wide power system generally operated between 34 kV and 100 kV including transmission, step-down transformers, area substations, and higher voltage area distribution, step down transformers and supply meters.

Microgrids generally include local distribution equipment. For example, microgrid equipment may include any or all of bulk power supply meter, substation, lower voltage distribution, breaker, switch, breaker/switch, load step-down transformer, and similar equipment. Microgrids are discussed further below.

Facilities include loads being supplied by the microgrid, including metering and sub-metering.

Distributed Generation is defined as any generation that ties into the facility electricity system (downstream or in parallel with facility meter) or generation connected to the microgrid electricity system (downstream or in parallel with the microgrid supply meter). Distributed generation can include waste heat recovery in the form of steam, hot water, or chilled water that is supplied to local facilities.

Methods of this invention include grid improvement methods benefitting from electric industry infrastructure data that is useful for purposes including performance evaluations. Any of fuel delivery systems, generating plants, area transmission and distribution, local distribution or microgrid, facilities, and the like can be rated. Moreover, infrastructure data along with industry stakeholder data can enable complementary performance evaluations such as consumer empowerment, safety, environmental compliance, and cost.

In various examples of rating systems, performance evaluations will include electric ratings for electric industry infrastructure near consumer interconnections such as local distribution and microgrid infrastructure involved in local distribution. Microgrids typically serve a specific constituent or set of consumers and consist of interconnected wires, distributed energy resources, and end-use loads for which metrics can be reported. Exemplary microgrid applications include municipalities, neighborhoods, universities and campuses of buildings, office parks, industrial parks, multiuse developments, and office towers.

In a microgrid paradigm of electric delivery, the electricity delivery system includes a network of interactive and intelligent microgrids. Like traditional local distribution infrastructure, microgrids link customers with the bulk power systems. Unlike traditional local distribution infrastructure, microgrids incorporate extended functionality. In various embodiments, microgrids include automated adaptation to changing needs and conditions of the bulk power system. Therefore, microgrids are not only served by the bulk power grid, they also provide valuable services, such as demand-response functionality, to the bulk power grid.

Augmenting and working in concert with the bulk grid, intelligent microgrids offer reliable, uninterrupted electric power while enabling customers to participate as partners and providers in the electricity enterprise. Intelligent microgrids integrate local resources at the community level and allow both consumers and suppliers to take full advantage of the smart grid transformation. This also allows intelligent microgrids to immediately island to serve local needs when the bulk power system is lost or prices are too expensive.

Performance metrics and system attributes are selected for the grid improvement methods (“GEM”) to work in conjunction with other ratings systems that focus at the building or facility level, such as ENERGY STAR and LEED. In addition, microgrids purchasing power from the bulk power system will need to obtain performance data for all of the GIM system metrics. This will require that the microgrid or local distribution company owners/operators gain access to the bulk power system performance data. In turn, the microgrid system owners/operators can require that suppliers provide the metrics outlined in electricity distribution franchise and power purchase agreements.

The proposed GIM can be applied to different types of local distribution systems or microgrids, for example: 1) A microgrid where the owner/operator of the grid also owns/operates the buildings being served (e.g., universities; large multi-use towers, etc.); and, 2) A microgrid where the owner/operator of the grid does not own the buildings and facilities being served (municipality or local distribution company).

Intelligent microgrids focus on the local power delivery system, one that meets the needs of electric consumers. Microgrid based local power delivery systems are manageable and accountable, enabling industry participants to partner with local government. Such partnerships enhance performance through, among other things, coordinated grid improvements and related infrastructure upgrades.

GIM include establishing a uniform rating system for businesses, consumers, and to encourage competition. In addition, GIM aims to educate stakeholders through increased awareness and to reveal gaps in performance. Grid performance metrics include consumer empowerment, cost, safety and reliability.

Consumer empowerment encourages consumer investment in automation and other technologies that reduce peak demand, as peak demand leads to inefficiencies in generating electricity, use of capital, and adverse environmental imp acts.

Safety and Reliability relates to issues with a potentially high cost to society. For example, power outages cost consumers about 150 billion dollars per year in the United States.

Environmental Performance also has a high societal cost. In various embodiments, GIM mitigates the effect of greenhouse gases and disease while reducing dependence on foreign oil.

Cost control is balanced with improvement to manage adverse cost impacts. For example, in some embodiments, distribution costs fall with lower peak demand and improved asset utilization. And, in some embodiments, grid infrastructure improvement is at no cost to the consumer.

Known rating systems or standards look at one performance measure aspect at a time, i.e. reliability, or environmental, or one particular stakeholder. Embodiments of GIM provide for evaluating multiple performance measures and in cases these performance measures are evaluated from data gathered in a single limited time period.

A governing body manages the rating system, sets certification requirements, tracks certification metrics, and issues certifications to applicants. This body engages in various business endeavors and recoups costs incurred in carrying out its rating system creation and operation mission.

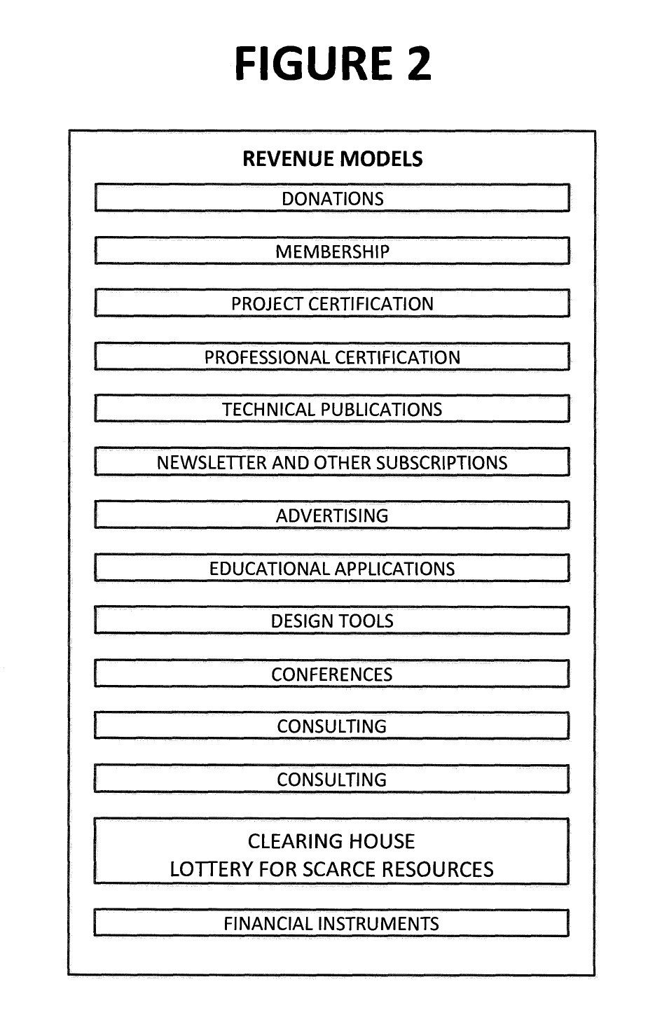

FIG. 2 shows targeted revenue models, any of which can be used to recoup costs. These revenue models are described below.

Donations are a first revenue source. The rating system governing body or board will seek donations from foundations, and interested stakeholder related to the issues the rating system attempts to address. Donations are also potentially available from customers, foundations and wealthy individuals. Methods of attracting donations include:

a. Educational materials promoting the awareness of the rating system and the issues it is attempting to improve;

b. Contact and develop relationships with targeted donors; and,

c. Press release and email blast to targeted donors.

Membership is a second revenue source. This includes membership for organizations that want to join a user's group for the rating system but not membership in the governing body. The customer group for membership would be inclusive of all donors, project certification customers, professional certification customers, technology providers, regulators, attorney generals, government stakeholders, and the investment community. Methods for attracting customer memberships include:

a. Members would get access to certain publications; and,

b. Discounts on products and services.

Project Certification is a third revenue source. This would include revenue collected for certifying microgrids, projects, and utilities. Certification customers include universities, developers, corporations including Fortune 500 Corporations, petro and chemical plants, medical centers, military bases, and municipalities. Methods for attracting project certifications include:

a. Pilot projects and case studies documenting the benefits; and,

b. Awards, competitions, and super bowls based on rating certified projects or projects under certification.

Professional certification is a fourth revenue source. Professional certification includes training for developers and designers of projects related to the rating system. Professional certification customers include individuals seeking professional certification, employees of the customers listed under Project Certification, as well as other interested parties such as consultants for these organizations, regulators, attorney generals and their staff, and technology providers. Methods for attracting professional certifications include:

a. Pull from the project certification business which and organizations considering certification;

b. Pull created from conferences based on the rating system; and,

c. Pull from introductory classes and web based educational materials based on the rating system.

Technical publications is a fifth revenue source, for example sale of metrics handbooks and other publications. This would include revenue from books, guides, and other education materials related to explaining the rating system metrics and how to improve your score. This would also include documentation for certifying bodies and explanation of data entry codes such as what the American Medical Association provides doctors' offices and insurance companies. Additional publications would include comparative reports and case study details. Customers would be similar to the target membership group. Methods for attracting publication sales include:

a. Certifiers will have to submit data using certain paper and web based forms requiring explanation form handbooks and other educational material; and,

b. Project managers and designers will need resources for improving designs and scores.

Newsletter and other subscriptions are a sixth revenue source. In addition to user group members and others may likely be interested in newsletter subscriptions and other documents related to the rating system. Topics for the newsletter would include upcoming changes or thinking around the rating, brief case studies, training materials, product reviews, and reports on user experiences. The target customer group here would be the same as the membership group. Methods for attracting newsletter and other subscription sales include email blasts, and advertisements through other products and services.

Advertising is a seventh revenue source. The governing body for the rating system will collect advertising revenue for advertisements in newsletters, other periodic publications, conference materials, websites, and apps. Customers include technology providers, certification consultants, and developments where the rating system has been applied. Methods of attracting advertising sales include upsells from targeted members and subscribers.

Educational Apps are an eighth revenue source. This would include revenue from educational smart phone applications and computer applications teaching consumers and stakeholder about the electricity system. Applications could include games; provide what-if scenarios or tools and resources for electricity consumers. Revenue could come from advertising as mentioned above or from sponsors such as museums and project developers. Customers include conference attendees, exhibit attendees, customers in special energy district and microgrid projects. Methods of attracting educational application revenues include user signs and instructions to download apps when the visit site

Design Tools are a ninth source of revenue. This includes revenue from sales of design tools to aid developers, designers, and planners for certification projects as well as developing projects that would eventually be certified by the rating system. Examples would include templates for failure modes and effects analysis and quality training tools. Customers include customers listed under project certification, professional certification and consultants. Methods of attracting design tool revenues include:

a. Upsell from project certification, and professional certification;

b. Awareness form rating system conferences; and,

c. Advertising in rating system materials and classes.

Conferences are a tenth source of revenue. This would include revenue from conferences based around the rating system and training events. Customers would be drawn from all potential membership customers. Methods of attracting conference revenues include:

a. Upselling from all products and services;

b. Embedded advertising in rating system materials; and,

c. Email database and blasts.

Consulting is an eleventh source of revenue. This includes consulting revenue from consulting for certifiers, parties undergoing the certification process, parties that are already certified but need to maintain their certification, and parties that are planning on certification. The governing body for the rating system will collect large amounts of data overtime which can be leveraged to help clients compare themselves to baselines and help them optimize their systems. This could include helping clients apply tools that they have already purchased and help provide technology providers design specifications. Customers include customers listed under project certification, professional certification and consultants. Methods for attracting email database and blast customers include:

a. Upsell from project certification, and professional certification;

b. Awareness form rating system conferences; and,

c. Advertising in rating system materials and classes.

Product certification and product rating provides a twelfth source of revenue. A basis for this includes information gained from verifying and tracking data and performance on systems with and without certification, members of the certifying body could offer other certifications, ratings and development new standards such as standards for interoperability and good design practices. Customers include technology providers, project certifiers, those with professional certification. Methods of attracting product certification and product rating customers include:

a. Reputation from successful projects; and,

b. Upselling from existing customers.

Clearing House or Lottery for scarce resources represents a thirteenth source of revenue. Through experiences related managing the rating system and tracking the related data, the members of the certify body will likely become aware of scarce resources, such as clean distributed generation generators, or low cost clean energy suppliers and act a clearing house to connect these resources with interested customers. Customers include the customers listed under project certification, professional certification and consultants. Methods for attracting clearing hous and lottery revenues include:

a. Upselling to existing customers;

b. Customer websites and portals; and,

c. Consumer rating website for services offered.

Financial Instruments are a fourteenth source of revenue. Through experiences related managing the rating system and tracking the related data, the members of the certify body will likely become aware needs for financial resources and loan program specific to different groups of customers. The members of the certifying body could work with banks and other financial institutions to develop specialized programs. Customers include the customers listed under project certification, professional certification and consultants. Methods of attracting revenue through the use of financial instruments include:

a. Upselling to existing customers;

b. Customer websites and portals; and,

c. Consumer rating website for services offered.

Primary indicia of performance used in the rating system include reliability, safety, power quality, cost, efficiency, environment, and consumer empowerment. As shown in the tables below, each of these primary indicia comprises points from a plurality of secondary indicia. Each secondary indicia is described by a corresponding; performance category, specific metric and point value. Further, each primary indicia has a maximum point value. Point values are determined by the governing body as are certifying scores for each primary indicia and for combinations of primary indicia scores.

Table 1 addresses the primary performance indicia safety, reliability, and power quality.

TABLE 2
Safety, Reliability, and Power Quality

| PERFORMANCE | | MAX | |
|---|---|---|---|
| CATEGORIES | SPECIFIC METRICS | POINTS | POINTS |
| Safety | | 10 | |
| Contact with outdoor power lines | Points for tracking related deaths and | | 5 |
| | injuries | | |
| Power interruption injuries and | Track and trend | | 5 |
| deaths | | | |
| Sustained Interruptions | | 60 | |
| 3-year SAIDI average | Points based on national averages | | 25 |
| 3-year SAIFI average | Points based on national averages | | 25 |
| CEMI-3 | Points for tracking | | 5 |
| CELID-8 | Points for tracking | | 5 |
| Momentary Interruptions | | 10 | |
| MAIFI | Points for tracking | | 5 |
| CEMMI-5 or other metric | Points for tracking | | 5 |
| Power Quality | | 20 | |
| Voltage variations (extended | Points for tracking | | 5 |
| duration) | | | |
| Voltage swells or dips | Points for tracking | | 5 |
| Voltage imbalance/phase | Points for tracking | | 5 |
| interruption | | | |
| High Speed Data Metrics (e.g., | Points for tracking | | 5 |
| harmonics) | | | |
| TOTAL SCORE POSSIBLE | | 100 | |

Table 2 addresses the primary performance indicia reliability by providing benchmarks reliability benchmarks.

TABLE 2
Reliability Benchmarks

| | | | | SCORING |
|---|---|---|---|---|
| | | SAIDI IEEE, | SAIFI IEEE, | CRITERIA |
| | | MINUTES OF | NUMBER OF | BASED ON |
| | | INTERRUPTION | INTERRUPTIONS | EQUAL TO OR |
| QUARTILE | PERCENTILE | DURATION | PER YEAR | BELOW |
| Min | 0 | 20.47 | .321 | 25 points |
| 1 | 25^{th} | 102.06 | 1.060 | 18 points |
| 2 | 50^{th} | 154.78 | 1.340 | 12 points |
| 3 | 75^{th} | 195.65 | 1.580 | 6 points |
| Max | 100^{th} | 493.26 | 3.220 | 0 points |

Table 3 addresses the primary performance indicia power quality by providing standards based on European Power Quality Standard EN 50160.

TABLE 3
European Power Quality Standard EN 50160

| POWER | | | |
|---|---|---|---|
| QUALITY | POWER QUALITY STANDARDS BY VOLTAGE LEVEL | | |
| METRICS | 0 < kV < 1 | 1 < kV < 35 | 35 < kV |
| Supply voltage | Nominal Voltage ± 10% | Contractual Voltage ± 10% | None |
| variations (for | (10 min mean 95% of the | (10 min mean 95% of the | |
| extended periods) | week); Nominal Voltage | week) | |
| | ±10/−15% (all 10 min mean | | |
| | values) | | |
| Voltage swells | Indicative: <1.5 kV (phase to | Generally <1.7 × U_{c} (earthed); | None |
| | earth) | Generally <2.0 × U_{c} | |
| | | (isol./resonant.) | |
| Voltage dips (sags) | Indicative: few tens up to | Same as Low Voltage | None |
| | one thousand | | |
| Voltage imbalance | ≦2% | Same as Low Voltage | None |
| | (10 min mean 95% of the | | |
| | week) | | |
| | ≦3% occur in some areas | | |

| | |
|---|---|
| Phase | The interruption of one or two phases of power on a customer three-phase |
| interruption | circuit for any period of time |

High-Speed Data Measures

| | | | |
|---|---|---|---|
| Frequency | Frequency is typically | Frequency is typically | See 1 < kV < |
| | governed by | governed by interconnection | 35 |
| | interconnection agreements | agreements to the | |
| | to the transmission system. | transmission system. EN | |
| | EN 50160 limits variation | 50160 limits variation to 2% | |
| | to 2% of the nominal | of the nominal frequency. | |
| | frequency. | | |
| Rapid voltage | Indicative: Generally <5% | Indicative: Generally <4% up | None |
| changes (RVC) | up to 10% | to 6% | |
| Flicker | Long Term Flicker (Plt) ≦1 | Same as Low Voltage (up to | None |
| | (95% of the week) | 1 kV) | |
| Harmonic voltage, | THD ≦ 8% | Same as LV | None |
| THD (total | (10 min mean 95% of the | | |
| harmonic | week) | | |
| distortion) | | | |
| Harmonic voltage | EN 50160 | Same as Low Voltage (up to | None |
| Individual | Table 1 | 1 kV) | |
| | (10 min mean 95% of the | | |
| | week) | | |

Source: The Council of European Energy Regulators' 4^{th} Benchmarking Report on Quality of Electricity Supply

Table 4 addresses the primary performance indicia cost.

Table 5 addresses the primary performance indicia efficiency and environment.

TABLE 5
Grid Efficiency and Environment

| PERFORMANCE | | MAX |
|---|---|---|
| CATEGORIES | SPECIFIC METRICS | POINTS |
| Energy Efficiency | | |
| Fossil fuel | Total fossil fuel consumed per MWh | 25 |
| source energy | delivered. This includes all grid losses to | |
| intensity | load meter | |
| Air Emissions | | |
| CO₂ | Total emissions in lbs per MWh delivered | 15 |
| NOₓ intensity | Total emissions in lbs per MWh delivered | 5 |
| SO₂ intensity | Total emissions in lbs per MWh delivered | 5 |
| Local impacts | Percent of generation from local fossil | 10 |
| | fueled generation | |
| Water | Total generation water consumption per | 15 |
| Consumption | MWh delivered | |
| Solid Waste | Percent of solid waste recycled | 15 |
| Impacts | | |
| Grid Impacts | Percent of T&D that is underground, % of | 10 |
| | local generation | |
| TOTAL SCORE | | 100 |
| POSSIBLE | | |

Source: The Galvin Electricity Initiative

Table 6 addresses the primary performance indicia consumer empowerment.

TABLE 6
Consumer Empowerment

| | | | |
|---|---|---|---|
| PERFORMANCE | SPECIFIC | MAX | |
| CATEGORIES | METRICS | POINTS | POINTS |

| | | |
|---|---|---|
| Access to usage date | Yes/No | 10 |
| Access to dynamic pricing | Yes/No | 10 |
| Generation supply choice | Yes/No | 10 |
| Access to long-term | Yes/No | 10 |
| financing | | |
| Interconnection standards | Yes/No | 10 |
| for consumer-owned | | |
| distributed generation | | |
| Net metering | Yes/No | 10 |
| Ancillary service payments | Yes/No | 10 |
| Consumer protection | Points for tracking | 10 |
| | ranking of suppliers, | |
| | and aspects of data | |
| | security, audits, and | |
| | definitions of data | |
| | rights | |
| Aggregation of meters | Yes/No | 10 |
| Consumer education | Yes/No | 10 |
| TOTAL SCORE | | 100 |
| POSSIBLE | | |

Source: Galvin Electricity Initiative

Each of the primary performance indicia is more fully explained in Appendix 1 of this patent specification.

While various embodiments of the present invention have been described above, it should be understood that they have been presented by way of example only, and not limitation. It will be apparent to those skilled in the art that various changes in the form and details can be made without departing from the spirit and scope of the invention. As such, the breadth and scope of the present invention should not be limited by the above-described exemplary embodiments, but should be defined only in accordance with the following claims and equivalents thereof.

What is claimed is:

1. A method of improving electric grid performance comprising the steps of:
providing a governing body, a rating system, and certification candidates;
the rating system incorporating
reliability as a first primary indicia of performance,
safety as a second primary indicia of performance,
power quality as a third primary indicia of performance,
cost as a fourth primary indicia of performance,
efficiency as fifth primary indicia of performance,
environment as a sixth primary indicia of performance, and
consumer empowerment as a seventh primary indicia of performance;
defining multiple factors for scoring each primary indicia of performance;
the governing body
determining a required primary indicia certifying score for each primary indicia of performance,
determining an overall certifying score for a plurality of the primary indicia of performance, and
authorizing auditors to perform audits on certification candidates;
selecting infrastructure certification candidates from at least one of electric generating infrastructure, electric transmission infrastructure, and electric distribution infrastructure;
auditing selected infrastructure candidates;
issuing a certificate of registration to infrastructure candidates that meet governing body requirements including certifying score as verified by an audit; and,
the governing body causing periodic publication of a list indicating electric industry participants holding certificates of registration.

2. The electric grid performance improvement method of claim 1 further comprising the step of evaluating reliability based on sustained electric power interruptions exceeding a selected duration.

3. The electric grid performance improvement method of claim 2 further comprising the step of evaluating reliability based on momentary electric power interruptions falling below a selected duration.

4. The electric grid performance improvement method of claim 3 further comprising the step of evaluating sustained electric power interruptions based on 3-year SAIDI averages as compared with national averages.

5. The electric grid performance improvement method of claim 4 further comprising the step of tracking sustained interruptions using CEMI-3 and CELID-8.

6. The electric grid performance improvement method of claim 5 further comprising the step of tracking momentary interruptions using MAIFI and CEMMI-5.

7. The electric grid performance improvement method of claim 6 further comprising the step of evaluating safety based on tracking the number of incidents when a human comes into contact with an outdoor electric power line.

8. The electric grid performance improvement method of claim 7 further comprising the step of evaluating safety based on tracking the number of injuries that are attributed to electric power interruptions.

9. The electric grid performance improvement method of claim 8 further comprising the step of evaluating safety based on tracking the number of deaths that are attributed to electric power interruptions.

10. The electric grid performance improvement method of claim 9 further comprising the step of evaluating power quality based on tracking voltage variations having a duration exceeding a selected voltage variation duration.

11. The electric grid performance improvement method of claim 10 further comprising the step of evaluating power supply quality based on tracking voltage swells and voltage dips.

12. The electric grid performance improvement method of claim 11 further comprising the step of evaluating power supply quality based on tracking at least one of phase voltage imbalance and phase power interruption.

13. The electric grid performance improvement method of claim 12 further comprising the step of evaluating power supply quality based on tracking high speed data metrics including harmonics metrics.

14. The electric grid performance method of claim 13 further comprising the step of evaluating cost based on electric power delivery costs.

15. The electric grid performance improvement method of claim 14 further comprising the step of evaluating cost based on electric power generation and transmission costs.

16. The electric grid performance improvement method of claim 15 further comprising the step of evaluating cost based on operating expenses including one or more of electric grid operating, maintenance, and repair costs.

17. The electric grid performance improvement method of claim 16 further comprising the step of evaluating cost based on capital spending including one or more of new installation costs, expansion costs, replacement costs, and improvement costs for electric power facilities and equipment.

18. The electric grid performance improvement method of claim 17 further comprising the step of evaluating costs based on indirect costs associated with one or more of electric power generation, transmission, and distribution.

19. The electric grid performance improvement method of claim 18 further comprising the step of evaluating costs based on tracking future spending using local spending plans that a) identify projects improving one or more of reliability, power quality, efficiency, and environment and b) rank those projects with a cost-benefit metric.

20. The electric grid performance improvement method of claim 19 further comprising the step of evaluating efficiency based on energy efficiency calculations considering both fuel consumption and benefits derived from the fuel consumption.

21. The electric grid performance improvement method of claim 20 further comprising the step of evaluating environment based on air emissions resulting from operation of electric power generating plants including one or more of carbon dioxide, nitrous oxides, and sulfur dioxide.

22. The electric grid performance improvement method of claim 21 further comprising the step of evaluating environment based on local impacts including one or more of water consumption, solid waste production, and fraction of total length of transmission and distribution facilities that are located below ground level.

23. The electric grid performance improvement method of claim 22 further comprising the step of evaluating consumer empowerment based on a) consumer access to one or more of consumer electric power usage data and b) electric power purchase and utilization consumer education programs.

24. The electric grid performance improvement method of claim 23 further comprising the step of evaluating consumer empowerment based on consumer choice in one or more categories including dynamic pricing tariffs, electric generation suppliers, and long-term financing providers.

25. The electric grid performance improvement method of claim 24 further comprising the step of evaluating consumer empowerment based on the availability to consumers of one or more of net metering, ancillary service payments, consumer protection services, and aggregation of electric power meters.
